(19) United States
(12) Patent Application Publication
(10) Pub. No.: US 2002/0155197 A1
(43) Pub. Date: Oct. 24, 2002

(54) Sugar wafer with confectionery filling and method for making same

(76) Inventors: David Klug, Marysville, OH (US); Leslie Bankirer, Dublin, OH (US)

Correspondence Address: WINSTON & STRAWN, PATENT DEPARTMENT, 1400 L STREET, N.W., WASHINGTON, DC, 20005-3502, US

(21) Appl. No.: 09/837,234

(22) Filed: Apr. 18, 2001

(51) Int. Cl. A23L 1/36

(52) U.S. Cl. 426/93

(57) ABSTRACT

A food product made of a sugar wafer that is preferably cone-shaped and that has a filling of a substantially water-free fat-based confectionery material. Also, a process for preparing this product by filling the sugar wafer with the substantially water-free fat-based confectionery in a molten, semi-liquid or semi-solid mass, and allowing the filling to harden.

### FIELD OF THE INVENTION

The present invention relates to a food product comprising a sugar wafer having a confectionery filling more particularly a fat-based confectionery filling.

### BACKGROUND OF THE INVENTION

It has long been known that standard fat-based confectionery such as chocolate normally melts in the hand on a hot day or if held for too long. In known wafer-containing chocolate or fat-based confections, the chocolate or compound is on the outside of the product, e.g., the Nestlé Kit Kat and Ferrero Roche products, and therefore the problem of the chocolate melting in the hand on a hot day or if held in the hand for too long exists. In these kinds of products where the chocolate is in contact with the hand, undesirable stickiness or dirtying of the hand can often occur.

U.S. Pat. No. 5,709,898 discloses a process for the manufacture of a food product comprising a wafer filled with a food core, the process including the steps of: (i) shaping the food core; (ii) heating at least part of the wafer in order to provide sufficient plastic properties to the wafer to shape; and (iii) shaping the wafer around the pre-shaped food core, the food core acting as a former. Optionally, a barrier coating is either pre-applied to the wafer prior to step (ii) or applied to the shaped food core after step (i). The food core is said to preferably be ice cream.

PCT application WO99/31996 discloses wafers filled with ice cream, mousse, cheese, vegetables and states that an inner coating provides the wafer with a sufficient resistance for softening due to moisture or due to the influence from the content. WO99/31996 also states that prior art wafer may be associated with problems, especially for children. If the wafer should have a food core having a certain volume then the cone, the cup or the hollow rod would have a great dimension which makes it difficult to handle. Thus, it is difficult to bite off the ice-cream from a large conical ice-cream in the same way as it also will be difficult to bite off the ice-cream which is provided in a cup-shaped wafer.

The foodstuffs disclosed in U.S. Pat. No. 5,709,898 and PCT application WO99/31996 contain substantial amounts of water, hence the desirability of a barrier coating between it and the wafer to prevent undesirable migration of water from the food core to the wafer which would cause the wafer to become soggy. Thus, improvements on these products are required, and the present invention provides such improvements.

### SUMMARY OF THE INVENTION

The present invention relates to a food product comprising a sugar wafer having a filling of a substantially water-free fat-based confectionery material. We have found that a sugar wafer cone, normally used for ice cream, can be filled with a substantially water-free fat-based confectionery filling to provide a “handle” which does not melt in hot weather or on prolonged handling and therefore serves to prevent undesirable stickiness and dirtying of the hands. In addition, this construction does not suffer from water migration problems and provides a product which combines the pleasure and fun of ice cream cones with the indulgence of a fat-based confection.

### DETAILED DESCRIPTION OF THE INVENTION

Wafers are normally made from batter recipes using from about 20% to 60% by weight of flour, water and sucrose (which may be brown or white) together with smaller quantities of one or more ingredients typically used in a sugar wafer such as fat, milk, cream, milk powder, whole egg, egg powder, soya flour, salt, lecithin, colorant, cocoa powder, flavors, emulsifiers, vanilla crystals and a raising agent.

The flour is usually wheat flour but it may be another flour such as rice flour or a flour admixed with a starch. Wafers usually have a low fat content, normally around 1-2% but in some cases up to 10% and the main function of the fat is as an antisticking/releasing agent. Sugar wafers as used in this invention differ from standard wafers in containing a higher sugar content than that of standard wafers which is usually less than 5%. The amount of sugar in in the sugar wafers of this invention may be from about 10% to 70%, for example from about 12.5% to 50% and more usually from about 14% to 40% by weight based on the weight of the sugar wafer.

Preferably, the sugar wafer is cone-shaped.

The fat-containing confectionery material may be any kind of chocolate, for instance, dark, milk or white chocolate. Chocolate normally has a maximum water content of about 2%, and more usually from about 0.5 to 1.5% by weight. The fat containing confectionery material may also include products derived from sugar with or without milk derived components, and fat and solids from vegetable or cocoa sources in differing proportions having a moisture content less than 10%, usually less than 5% by weight and more usually less than 2% by weight. The fat containing confectionery material may include chocolate substitutes containing direct cocoa butter replacements or cocoa butter alternatives which are vegetable fats such as cocoa butter equivalents (CBE) or cocoa butter substitutes (CBS) which are well known to those skilled in the art, e.g. CBS laurics and CBS nonlaurics ( see Chocolate, Cocoa, and Confectionery; Third Edition, 1989, Bernard W. Minifie; AVI, pp100-109), e.g., stearines, coconut oil, palm oil, butter or any mixture thereof; nut pastes such as peanut butter and fat; praline; confectioner's coatings also known as compound or couvertures, used for covering ice cream or cakes usually comprising chocolate analogues with cocoa butter replaced by a cheaper non-tempering fat; or “Caramac” sold by Nestlé comprising non-cocoa butter fats, sugar and milk. For example, the fat-containing confectionery material may be peanut butter or a blend of chocolate and a vegetable fat containing, for instance, from about 60 to 90% chocolate and from about 40 to 10% of a vegetable fat. The vegetable fat is advantageously a non-lauric fat, for example, palm, soy or cottonseed oils. Non-lauric fat is preferred over non-lauric fat due to its greater compatibility with chocolate.

The food product may have a weight from 5 to 40 grams. Within this range, the product may be bite-sized weighing from 5 to 15 grams or a 2-3 bite piece weighing from above 15 grams to 40 grams, preferably from 20 to 30 grams. When our food product is bite-sized or a 2-3 bite piece, there are the following advantages:

1) There are no handling and biting difficulties as in prior art wafers because the diameter of the top of the cone is is sufficiently small to fit into ones mouth for biting the filling. In this respect, PCT patent application WO 99/31996 teaches away from the present invention by stating that these difficulties can be solved by using a fan-shaped wafer instead of a cone-shaped wafer as in our invention.

2) The cone serves to keep the hands clean during eating.

3) Traditionally, fillings are in a chocolate or compound shell. When these fillings are fat-based, care must be taken to avoid fat migration from the filling to the shell material. This is a normal problem when the filling contains a high proportion of liquid fat at room temperature. When the fat migrates from the filling to the shell there is a tendency towards softening the chocolate or compound shell. This is important as soft creamy fillings are especially appreciated by the consumer but soft shells are not. Many cases of fat migration to the shell are known by those familiar with the art. Center fillings made with nut pastes show a high tendency of having migration problems (e.g. Reese's Peanut Butter Cups). One method of combat is to remove a portion of the nut oil by pressing (i.e.—reduced fat peanut flours). The resulting products do not have the same fresh flavor as full fat nut pastes. By encasing our fillings in a wafer, this problem is avoided, allowing us to have higher percentages of liquid oil promoting a soft creamy texture as well as allowing the incorporation of high levels of full fat nut pastes without the worry of having a soft and messy chocolate shell.

Optionally, edible inclusions such as chopped nuts, candy pieces, raisins, etc. may be the incorporated in the fat-containing confectionery material.

Any inclusions containing substantial amounts of water are preferably encased within the fat-containing confectionery material.

Optionally, a fat-based coating is applied to the inside surface of the sugar wafer to enhance the flavor of the food product.

If desired, the food product may have a topping of chocolate or confectionery coating. Optionally, edible inclusions such as chopped nuts, candy pieces, raisins, etc. may be added to the topping.

The present invention also provides a process of preparing a food product comprising a sugar wafer having a substantially water-free fat-based confectionery filling which comprises filling the sugar wafer with the substantially water-free fat-based confectionery in a molten, semi-liquid or semi-solid mass, and allowing the filling to harden.

Advantageously, a coating of chocolate or compound is first applied to the inside of the wafer. This may be performed either by filling the wafer with the chocolate or compound in a molten state and then inverting the wafer, optionally with vibration, to empty excess coating or preferably by spraying the coating of chocolate or compound onto the inside surface of the wafer. Afterwards, the coating is allowed to harden and the coated wafer is then filled with a molten, semi-liquid or semi-solid mass of another fat-based confectionery material, optionally with edible inclusions incorporated therein, which is subsequently allowed to harden.

### EXAMPLES

The following Examples further illustrate the present invention.

### Example 1

A bite-size product weighing 12.9 grams is prepared from a sugar wafer cone weighing 3.2 grams, filling with liquid compound coating having a fat component of partially hydrogenated palm kernel oil and emulsifier (lactic acid esters of monoglycerides), inverting the cone and applying a vibration to empty leaving a thin layer of compound coating weighing 1.6 grams on the inside surface of the cone. Optionally, the interior of the cone can be sprayed with the coating instead thus eliminating the need to invert the cone to empty excess coating. The coating is allowed to harden and the sugar wafer cone is filled with 6.0 grams of a semi-solid peanut butter mass comprising 25% peanut butter and 39% white compound coating with a fat composition of fractionated palm kernel oil and palm stearine encasing 36% of candy pieces sized by sifting through US Standard Sieves using pieces that go through a 5 mesh sieve and retained on a 12 mesh sieve. The composition of the candy pieces is as follows: Sugar, Corn Syrup, Ground Roasted Peanuts, Partially Hydrogenated Palm Kernal Oil, Cocoa, Molasses, Confectioner's Corn Flakes, Skim Milk, Whey, Salt, Monoglycerides, Soy Lecithin, Cornstarch, Artificail Flavors, Yellow 5, TBHQ and Citric Acid (to preserve freshness), Red 40. The top of the filling is domed to appear similar to an ice cream cone. The filling is allowed to harden and the filled cone is dipped into 1.0 grams of a chocolate compound coating containing sugar, partially hydrogenated palm kernal oil, cocoa solids, butter milk solids, soy lecithin, salt, ethyl vanillin (moisture less than 1%) and then immediately dipped into 1.1 grams candy pieces. The product obtained combines the pleasure of ice cream cones with the indulgence of a fat based confection.

### Example 2

A 2-3 bite product weighing 28.1 grams is prepared from a sugar wafer cone weighing 5.1 grams, filling with liquid compound coating having a fat component of partially hydrogenated palm kernel oil and emulsifier (lactic acid esters of monoglycerides), inverting the cone and applying a vibration to empty leaving a thin layer of compound coating weighing 3.2 grams on the inside surface of the cone. Optionally, the interior of the cone can be coated by spraying the interior of the cone with the compound coating, eliminating the need to invert the cone to empty excess coating. The coating is allowed to harden and the sugar wafer cone is filled with 9.9 grams of a semi-solid peanut butter mass comprising 45% peanut butter and 55% white compound coating with a fat composition of Fractionated Palm Kernal Oil and Palm Stearine, encasing 2.0 grams of caramel. The top of the filling is domed to appear similar to an ice cream cone. The filling is allowed to harden and the filled cone is dipped into 1.6 grams of a chocolate compound coating containing sugar, partially hydrogenated palm kernal oil, cocoa solids, butter milk solids, soy lecithin, salt, ethyl vanillin (moisture less than 1%) and then immediately dipped into 2.3 grams of chopped peanuts followed by a second dipping into 4.0 grams of a chocolate compound coating.

The product obtained combines the pleasure of ice cream cones with the indulgence of a fat based confection while being easy to handle and bite.

### Example 3

A single bite-size product weighing 11.5 grams is prepared from a sugar wafer cone weighing 3.4 grams, filling with 7.0 grams of a tempered semisolid mass comprising a blend of 72% milk chocolate and 18% of a non-lauric vegetable fat (partially hydrogenated cottonseed and soybean oil) and 10% crisped rice, doming to give the appearance of an ice cream cone and allow to harden. Finally, the filled cone is dipped in 1.1 grams of tempered milk chocolate to coat the tops.

The product obtained combines the pleasure of ice cream cones with the indulgence of a fat based confection while being easy to handle and bite.

What is claimed is:

1. A food product comprising a sugar wafer having a filling of a substantially water-free fat-based confectionery material.

2. A food product according to claim 1 wherein the sugar wafer is cone-shaped.

3. A food product according to claim 1 wherein the food product is bite-sized or a 2-3 bite-sized piece.

4. A food product according to claim 1 wherein the filling has a water content of less than 10%.

5. A food product according to claim 1 wherein the filling is dark, milk or white chocolate, products derived from sugar with or without milk derived components, and fat and solids from vegetable or cocoa sources in differing proportions, chocolate substitutes containing direct cocoa butter replacements, stearines, coconut oil, palm oil, butter or any mixture thereof; nut pastes, praline or confectioner's coatings comprising chocolate analogues with cocoa butter replaced by a cheaper non-tempering vegetable fat containing from about 60 to 90% chocolate and from about 40 to 10% of a vegetable fat.

6. A food product according to claim 1 wherein the filling is a blend of chocolate and a non-lauric vegetable fat.

7. A food product according to claim 1 wherein a fat-based coating is present on the inside surface of the sugar wafer.

8. A food product according to claim 1 wherein edible inclusions are incorporated in the fat-containing confectionery material.

9. A food product according to claim 8 wherein any inclusions containing substantial amounts of water are encased within the fat-containing confectionery material.

10. A process for preparing a food product comprising a sugar wafer having a substantially water-free fat-based confectionery filling which comprises providing the sugar wafer in a desired shape, introducing a substantially water-free fat-based confectionery in a molten, semi-liquid or semi-solid mass upon or into the sugar wafer, and allowing the confectionery to harden to form the food product.

11. A process according to claim 10, wherein the sugar wafer is provided in the shape of the cone and the confectionery is introduced to at least partially fill the cone.

12. A process according to claim 11, wherein a fat-based coating is applied to the interior surface of the cone before the confectionery is introduced therein.
